(19) United States
(12) Patent Application Publication
(10) Pub. No.: US 2026/0220263 A1
(43) Pub. Date: Jul. 30, 2026

(54) RESOURCE SENSITIVITY LABELLING BASED ON SCANNING BY A WEB BROWSER

(71) Applicant: Palo Alto Networks, Inc., Santa Clara, CA (US)

(72) Inventors: Ofer Ben-Noon, Tel Aviv (IL); Guy Harpak, Ramat Gan (IL); Eran Rom, Tel Aviv (IL); Nir Adler, Netanya (IL); Gilad Roth, Modi'in Makabim-Re'ut (IL); Yan Aksenfeld, Rehovot (IL); Gal Moshe Shalev, Pardes Hanna-Karkur (IL); Ido Salomon, Tel Aviv (IL); Alona Miga Blend, Herzliya (IL); Yonatan Meir Shimonovich, Kiryat Ono (IL); Shlomi Zrahia, Tel Aviv (IL); Yinon Englesman, Giv`At Shmuel (IL); Eliazar Edward Sikuriansky, Tel Aviv (IL); Chen Siedner, Brooklyn, NY (US)

(21) Appl. No.: 19/542,516

(22) Filed: Feb. 17, 2026

Related U.S. Application Data
(63) Continuation of application No. PCT/IL2024/050828, filed on Aug. 17, 2024.
(60) Provisional application No. 63/520,099, filed on Aug. 17, 2023.

(51) Int. Cl. G06F 21/55

(52) U.S. Cl. CPC G06F 21/554; G06F 2221/034

(57) ABSTRACT

A web browser determines whether resources (e.g., files) of an enterprise are labelled in alignment with their contents. The web browser identifies a resource of the enterprise that comprises a sensitivity label, where the sensitivity label indicates sensitivity of the first resource. The web browser validates the sensitivity label of the first resource based on content of the first resource. If the sensitivity label does not align with the content of the first resource, the web browser enforces a policy for the first resource. The web browser then labels the first resource based on its sensitivity, which include scanning the first resource for sensitive features.

### FIELD

Embodiments of the disclosure relate to providing cybersecure access channels and workspaces for communications networks and digital resources.

### BACKGROUND

The various computer and communications technologies that provide modern communications networks and the Internet, encompass a large variety of virtual and bare metal network elements (NEs) that support operation of the communications networks and the stationary and/or mobile user equipment (UE) that provide access to the networks. The technologies have enabled the information technology (IT) and the operations technology (OT) that are the bedrocks of today's society and provide a plethora of methods, devices, infrastructures, and protocols for controlling industrial equipment, supporting business operations, and generating and propagating data, voice, and video content via the Internet. Information of all types is readily available through the internet to most of the global population, independent of physical location. And today, large segments of the global community regularly work remotely from their homes, coffee shops, and vacation venues via connectivity to their employers and work groups using their personal, Bring Your Own Device (BYOD), UEs—such as their personal smartphones, laptops, tablets, and home desktops. The networks have democratized the consumption of information and accelerated changes in societal infrastructure.

However, the benefits provided by the computer and communications technologies are not without their costs. The same technologies and benefits have substantially increased the difficulty in providing and maintaining legitimate personal and collective rights to confidentiality, and in protecting the integrity and safety of the selfsame industrial and business operations that the technologies have enabled against violation and damage from cyberattacks.

For example, a fingerprint of cyberattack surfaces characterizes each UE, whether it is a personal, spatially untethered BYOD or an enterprise, workplace user equipment (WPUE) and provides vulnerabilities for exploitation by malicious hackers to wreak havoc possibly on the UE and more often on entities and systems to which the UE connects. Each UE, and in particular a BYOD, in addition to functioning as a person's communications node, is a potential cyberattack node for any communications network to which the UE connects. For enterprises that must be in contact with clients, workers, and/or associates that have segued at least in part to remote work using their personal BYODs, vulnerability to cyberattack is amplified by a number of their remote contacts, the software configurations in the contacts' respective BYODs, and the manifold of non-enterprise communications that the contacts engage in using the UEs. The gravitation of enterprise data and storage resources to the cloud and the proliferation of technologies such as Infrastructure as a Service (IaaS), Platform as a Service (PaaS), and Software as a Service (SaaS) that remote contacts access and use further compounds the complexity of providing for appropriate cyber protection.

### SUMMARY

An aspect of an embodiment of the disclosure relates to providing a cyber secure communications system, optionally referred to as a CyberSafe system or simply “CyberSafe”, that provides enhanced visibility and management of communications traffic propagated by the system. CyberSafe leverages the enhanced visibility to provide improved cyber protection for, and secure access to a digital resource of a body of resources for an authorized user of a UE—a BOYD or a WPUE—associated with the body of resources.

Digital resources include any information in digital format, at rest or in motion, and comprise by way of example electronic documents, images, files, data, databases, and/or software, which refers to executable code and/or data. Digital resources also include any software and/or hardware that may be used to operate on or generate a digital resource. A digital resource in motion is a digital resource that is being used, and/or operated on, and/or in transit between nodes of a communication system. A digital resource at rest is a digital resource that is in storage and not in motion.

For convenience of presentation, it is assumed that the body of digital resources is owned by an enterprise, optionally referred to as “MyCompany”, that employs or engages in tasks with users authorized to use a UE associated with the body of resources to access a MyCompany resource. A UE associated with the body of resources is a UE that has been configured in accordance with an embodiment of the disclosure to enable an authorized user access to a MyCompany resource and may be referred to as a MyCompany UE. A user authorized to use a MyCompany UE to access a MyCompany resource may be referred to as a MyCompany user or simply a user.

In an embodiment CyberSafe comprises an, optionally cloud based, data and processing security hub, also referred to as a CyberSafe hub, and a web browser, also referred to as a CyberSafe secure web browser (SWB), resident in a CyberSafe isolated secure environment (CISE) of a MyCompany UE configured by, or in accordance with, CyberSafe. In an embodiment, CISE operates to isolate software comprised in the SWB and in other applications that may reside in CISE from software in the UE, also referred to as UE ambient software, that may be used for tasks not associated with MyCompany resources, and from software external to the UE. In an embodiment the SWB monitors and controls movement of data into and out from CISE and between applications in CISE and access to MyCompany resources to enforce CyberSafe and/or MyCompany security policies. In an embodiment Cybersafe supports high resolution monitoring and control of motion of data into and out from CISE and propagation of data by the communications system by configuring the SWB to provide high visibility to the motion of the data. Providing high visibility comprises making communications outgoing from CISE visible before the SWB encrypts the outgoing communications and communications incoming into CISE after the SWB decrypts the incoming communications. The isolation and control of movement and access to data, and enforcement of security policies in accordance with an embodiment of the disclosure operate to provide enhanced protection against cyber damage and security against leakage of data from and/or into MyCompany resources that may result from communication with and via a MyCompany UE.

Isolation and control comprises providing a procedure for enrolling a user and a UE to MyCompany CyberSafe so that they are recognized and identifiable by CyberSafe and constraining access to MyCompany resources to enrolled users and UEs. In an embodiment, the enrolling procedure provides a user and a UE that the user may use for access to a MyCompany resource a context of identities and identification tools, optionally referred to as context data, for use in signing in to use a MyCompany resource. CyberSafe processes the context data when a user attempts to sign in to MyCompany to determine whether or not to provide the user with access to the MyCompany resource. The identities may by way of example, comprise an ID for a MyCompany user (U-ID), an ID for a MyCompany user equipment (UE-ID), and/or an ID for a secure web browser (B-ID) housed in the MyCompany UE. The identity tools may by way of example, comprise passwords, tokens, public, and/or private keys.

In an embodiment monitoring and controlling motion of digital data comprises vetting information content of the data and controlling the motion of the data responsive to the vetted content. Vetting content may comprise determining textual, image, audio, and/or video components of the data and processing the components to determine their respective information content. Controlling motion of the data responsive to data content may comprise labeling and characterizing data content, controlling access to the data, vetting the data, such as by way of example a password, so that the data is constrained to satisfy policy constraints, and/or obfuscating the data, optionally responsive to assessments of confidentiality of the data and clearance of a user engaging with the data.

Monitoring and controlling data motion may comprise monitoring user behavior operating and using a MyCompany UE to determine user key performance indicators (U-KPIs) that characterize the user behavior when interacting with the MyCompany UE and MyCompany digital resources and using the U-KPIs to control data motion. Optionally, monitoring user behavior comprises recording and storing at least a portion of a communication session that the user engages in using the MyCompany UE.

Optionally, monitoring motion of data may comprise determining activity groups of communicating entities that comprise a user, a company resource, and/or a website or other communicating entity internal or external to MyCompany, to detect and operate to preempt, optionally in real time, cyber risks to which MyCompany may be exposed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale

FIG. 1 schematically shows a MyCompany UE configured having a CyberSafe CISE and SWB to provide cyber security to an enterprise referred to as MyCompany, in accordance with an embodiment of the disclosure;

FIGS. 2A-2C show a flow diagram of a procedure by which the SWB shown in FIG. 1 may engage in a handshake with a CyberSafe hub to acquire a token for use in accessing a MyCompany resource, in accordance with an embodiment of the disclosure;

FIGS. 2D-2E show flow diagrams of CyberSafe methods for securing and using a user ID (U-ID) and a user equipment ID (UE-ID) for accessing a MyCompany resource, in accordance with an embodiment of the disclosure;

FIG. 3 shows a flow diagram illustrating a method, optionally referred to as Dynamic Password Filtering for controlling creation of passwords, in accordance with an embodiment of the disclosure;

FIG. 4 shows a flow diagram for a method, optionally referred to as Scrambler, for obfuscating a data stream that a user generates operating a human-computer interface device, such as a keyboard or mouse, in accordance with an embodiment of the disclosure;

FIG. 5A schematically shows a multiplanar graph having user, resource, and website graphs advantageous for visualizing and processing relationship between entities relevant to activity of an enterprise in accordance with an embodiment of the disclosure;

FIG. 5B schematically shows a set of entities exhibited in FIG. 5A that form an activity group of interacting entities advantageous for identifying and intercepting cyber threats in accordance with an embodiment of the disclosure;

FIG. 6A shows a flow diagram for a method, optionally referred to as Resource Confidential Labeling, (RECON), for generating a digital signature based on confidentiality levels assigned to material that the resource comprises, in accordance with an embodiment of the disclosure; and

FIG. 6B shows a flow diagram of RECON operating to vet and control motion of a resource in accordance with an embodiment of the disclosure;

### DETAILED DESCRIPTION

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily a required configuration of possible embodiments of the disclosure. Unless otherwise indicated, the word “or” in the description and claims is considered to be the inclusive “or” rather than the exclusive or, and indicates at least one of, or any combination of more than one of items it conjoins. Whereas features and actions of flow diagrams shown in the figures and discussed in the specification are presented and discussed substantially in a sequential order prescribed by sequential block numbers referencing blocks in the figures, actions presented in the blocks may be undertaken simultaneously or in orders at different times that are not prescribed by the block numbers.

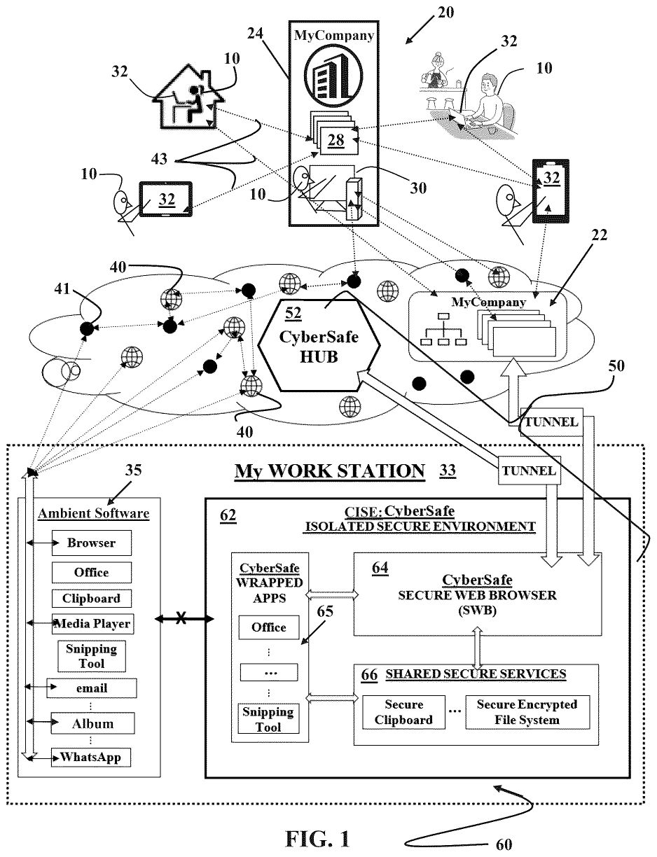

FIG. 1 schematically shows a CyberSafe system 50 that operates to provide cyber secure communication for a communications network of an enterprise 20, also referred to as MyCompany 20 or simply MyCompany, and for MyCompany users 10 that use the communications network, in accordance with an embodiment of the disclosure. MyCompany may have cloud based digital resources 22, premises 24 housing on-premise servers (not shown) for storing and processing MyCompany on-premise digital resources 28, and WPUEs 30 for use by MyCompany users 10 when on-premise for accessing, using, and processing the cloud based and on-premise resources to conduct MyCompany business. MyCompany may permit users 10 when off-premise to access MyCompany resources from various locations using any of various types of BYODs 32. It is assumed that MyCompany users 10 may use their respective BYODs 32 for personal activities, and that MyCompany users when on-premise may, in accordance with permissions defined by MyCompany policy, be allowed to use WPUEs 30 for personal activities. Personal activities may include web browsing, social networking, uploading, and downloading material, via the cloud infrastructure of communication nodes 41 and websites 40. The MyCompany network, may be required to support, as schematically indicated by double arrowhead dashed lines 43, communication between any of various combinations of MyCompany on-premise digital resources 28, cloud based digital resources 22, on-premise users 10 using WPUEs 30 installed in a MyCompany premises 24, and off-premise users 10 using BYODs 32 at various off-premise locations.

In accordance with an embodiment of the disclosure CyberSafe 50 comprises an optionally cloud based CyberSafe processing and data hub 52 and a software architecture 60 that operates to cyber protect MyCompany communications and digital resources in each of a plurality of MyCompany UEs, BYODs 32, and/or WPUEs 30 used by MyCompany users 10 to access and use MyCompany resources. CyberSafe hub 52 comprises and/or has access to cloud based and/or bare metal processing and memory resources required to enable and support functionalities that the hub provides to CyberSafe 50 and components of CyberSafe.

In an embodiment hub 52 comprises a user management module U-Mng 52.1, a user equipment management module UE-Mng 52.2, and a policy engine, Pol-Eng 52.3. U-Mng 52.1 comprises software that support functionalities that hub 52 provides for identifying MyCompany users and supporting their access to and use of MyCompany resources. U-Mng 52.1 comprises a database having data records comprising data that identify and profile MyCompany users and software for using the data and metadata in supporting the functionalities. UE-Mng 52.2 comprises software that supports functionalities that hub 52 provides for identifying MyCompany user equipment UE and facilitating use of the UE by MyCompany users. UE-Mng 52.2 comprises a database having UE data records comprising data that identify and characterize software and/or hardware of the UEs. Pol-Eng 52.3 comprises software that supports functionalities that hub 52 provides for implementing MyCompany security policies. Pol-Eng 52.3 includes a repository of MyCompany policy items that includes policy rules, guidelines, and/or practices, and software for accessing and using the policy items.

By way of example, FIG. 1 schematically shows CyberSafe software architecture 60 that configures a MyCompany UE 33, to protect MyCompany digital resources, at rest and/or in motion, and provides cyber secure access to the resources for a user 10 that may use MyCompany UE 33. MyCompany UE 33 may be a BYOD or a WPUE.

Architecture 60 comprises a CyberSafe isolated environment, CISE 62, that is isolated from ambient software 35 resident in UE 33 and comprises a SWB 64, resident in CISE 62. In an embodiment SWB 64 may comprise a browser extension, EXT, that performs tasks involved with enrolling UE 33 to MyCompany CyberSafe and mediating connecting and accessing UE 33 to MyCompany resources and/or monitoring interaction of UE 33 with the resources. Ambient software 35 may typically include data and applications that are not intended for use in conducting MyCompany business. By way of example, ambient software 35 may comprise a browser, an office suite of applications, a clipboard, an album of family images, a photo album and WhatsApp. CISE 62 may also include a set 65 of applications optionally imported from ambient software 35 and wrapped and optionally containerized by CyberSafe to associate cybersecurity features required by CyberSafe and/or MyCompany policy features with the applications. In an embodiment CISE comprises an ensemble of shared secure services 66 that may be accessed for use by SWB 64 and by applications in set 65 via SWB 64. Shared secured service 66 optionally comprise a secure clipboard and a secure encrypted File System.

CISE 62 provides an isolated security domain delimited by a substantially continuous security perimeter generated and supported by security applications, features, and functionalities of SWB 64, shared secure services 66, and wrapping of wrapped applications 65. In accordance with an embodiment, CISE 62 may be configured to provide cyber security and isolation using methods of, and compliant with, such standards as PCI DSS (Payment Card Industry Data Security Standard), HIPAA (Health Insurance Portability and Accountability Act), and/or SOC2 (American Institute of CPAs' Service Organization Control). Optionally CISE 62 is isolated from the ambient software on the network level. In an embodiment CISE 62 comprises a Trusted Platform Module (TPM) 71 operable to generate and store cryptographic keys and optionally provide integrity measurements to support a root of trust for UE 33 in interacting with MyCompany. In an embodiment CISE comprises at least one watchdog (Wdog) 72 configured to monitor and/or perform integrity tests of SWB 64, and/or components, such as EXT 64.1, of SWB.

In an embodiment to provide isolation and security, SWB 64 is configured to monitor and control ingress and egress of data respectively into and out from CISE 62 and between applications in CyberSafe wrapped applications, shared secure services 66 and/or SWB 64. SWB 64 is advantageously configured by CyberSafe to enforce CyberSafe and/or MyCompany security policies relevant to access to MyCompany data and movement of data within and into and out from CISE. The isolation and control of movement of and access to data, and enforcement of policies operate to provide enhanced protection against cyber damage and security against leakage of data from and/or into MyCompany resources that may result from communication with and via a MyCompany UE.

In an embodiment, monitoring ingress and egress of data comprises monitoring communications supported by SWB 64, storing and processing data comprised in the monitored communications and making the data available to the CyberSafe hub and to MyCompany IT. In an embodiment, monitoring is performed on communications outgoing from CyberSafe isolated environment CISE 62 (FIG. 1) before the outgoing communications are encrypted by SWB_{b} and on communications incoming into CISE after the incoming communications are decrypted by SWB 64. As a result, user browsing is substantially completely visible to CyberSafe and to MyCompany and can be processed locally or remotely.

Monitoring may be substantially continuous, stochastic, or periodic. Stochastic monitoring comprises monitoring communications for monitoring periods of limited duration that begin at onset times that are randomly determined, optionally in accordance with a predetermined probability function or in response to a “trigger” event such as an event that is considered anomalous and warrants attention. Periodic monitoring comprises continuous monitoring of communications during monitoring periods at periodic onset times. Monitored communications may be mirrored by SWB 64 to a destination in CyberSafe hub and/or MyCompany for storage and/or processing or may be filtered for data of interest before being transmitted to a destination in CyberSafe hub and/or MyCompany for storage and/or processing. Features and constraints that configure how monitored communications are handled by SWB 64 may be determined based on CyberSafe and/or MyCompany policy. Such policy may specify how processing of data is shared between the local SWB and the CyberSafe hub.

In an embodiment, SWB 64 may be an independent application comprising CyberSafe features and/or functionalities, or an existing web browser, such as Google Chrome, Microsoft Edge, Apple Safari, Mozilla Firefox, Opera, or Brave, modified and provided with additional CyberSafe features and/or functionalities by changes and/or additions to browser code and/or by integrating with CyberSafe extensions. The features and functionalities may be incorporated into the existing browser and the browser converted to a CyberSafe SWB by: interfacing with the input and output of the existing browser using operating system hooks; patching the original binary of the browser; building a dedicated extension on top of the browser's API and/or SDK; and/or dynamically modifying memory of the browser when the browser is in operation.

By way of example, the features and/or functionalities, hereinafter generically referred to as functionalities, may comprise, at least one or any combination of more than one of functionalities that enable SWB 64 to: cooperate with a MyCompany IDP to verify and authorize a user 10 to access CISE 62 and MyCompany resources; acquire data characterizing websites visited by MyCompany users that may be used to classify cyber risks associated with the websites; acquire data characterizing browser extensions that may compromise SWB 64 security features; acquire data that may be processed to determine normal behavior and use of MyCompany resources by MyCompany users as a group and/or as individuals; monitor engagement of a MyCompany user with a MyCompany resource and control the engagement to enforce CyberSafe and/or MyCompany security constraints.

In an embodiment enforcing CyberSafe and/or MyCompany security constraints comprises requiring that all communications between UE 33 and a MyCompany resource be propagated via SWB 64 and CyberSafe tunnels that connect the SWB to the resource and enforcing CyberSafe and/or MyCompany permissions to the resources. Optionally, enforcing security constraints comprises identifying anomalies in communications between UE 33 and a company resource and operating to eliminate or ameliorate damage from an identified anomaly and generate an alert to its occurrence.

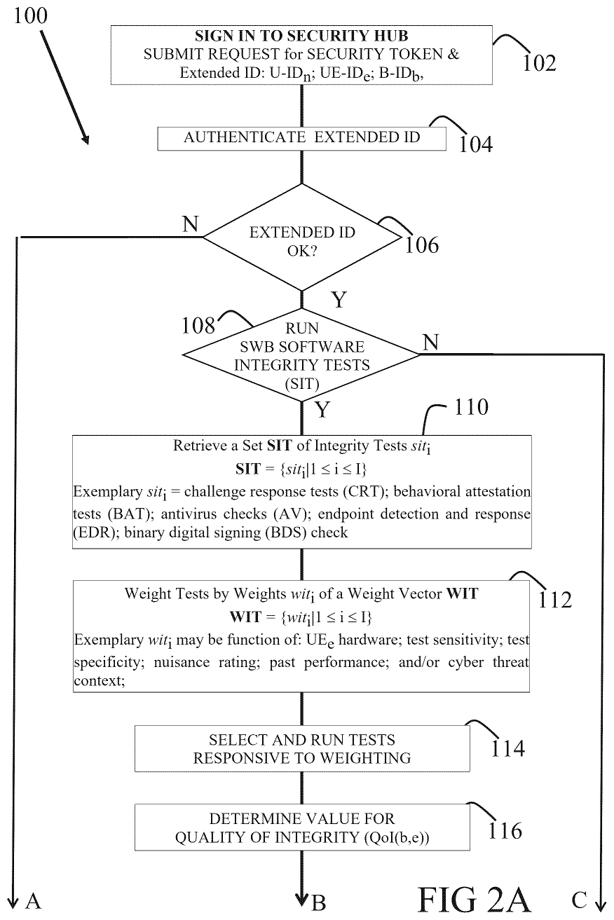

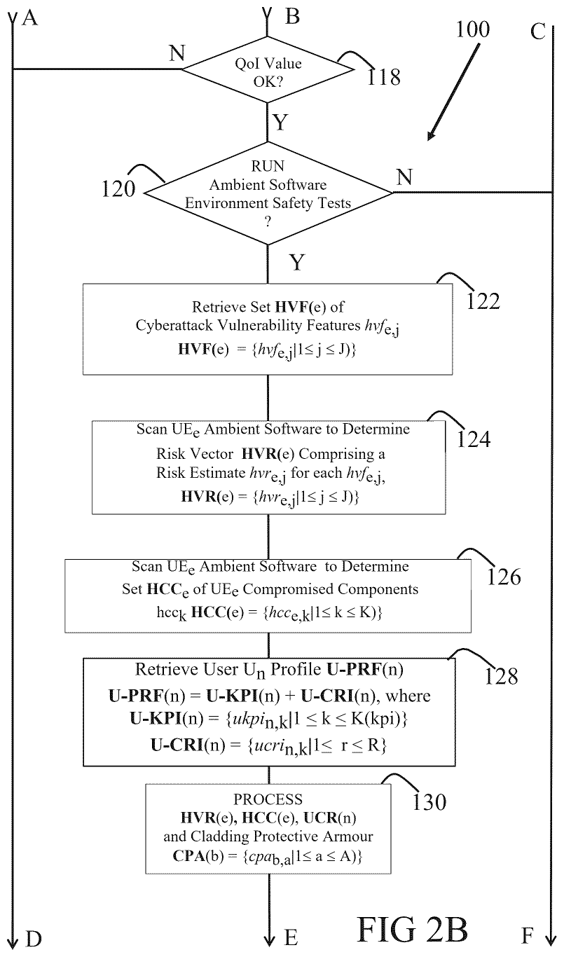

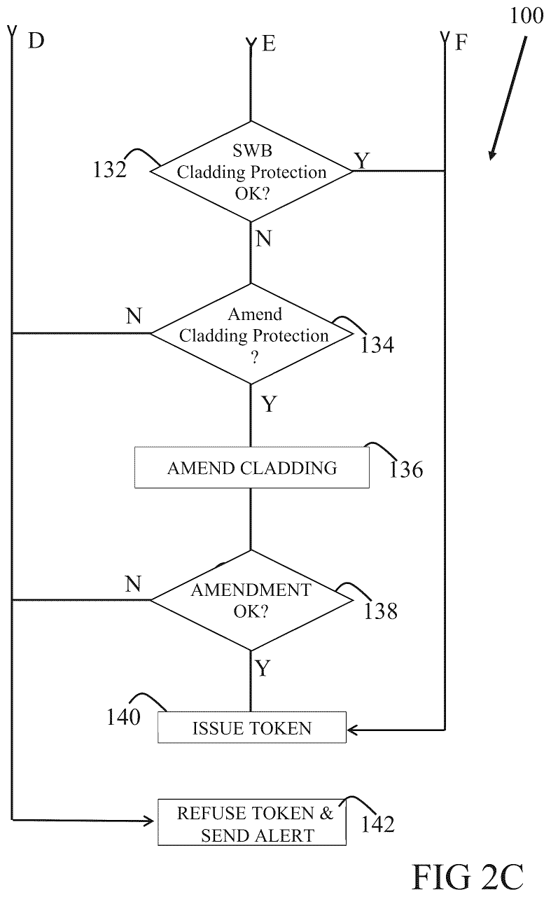

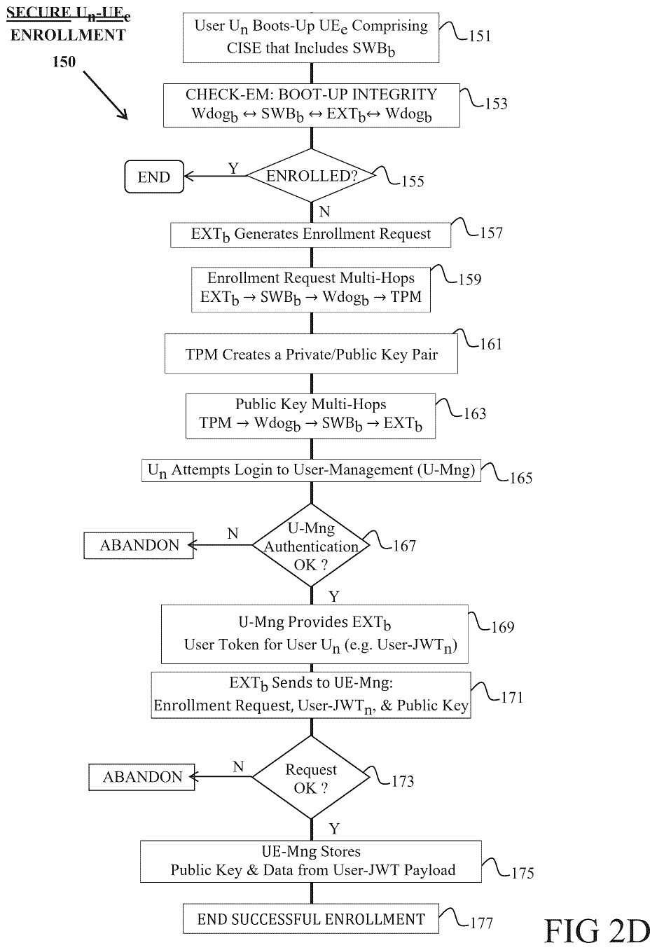

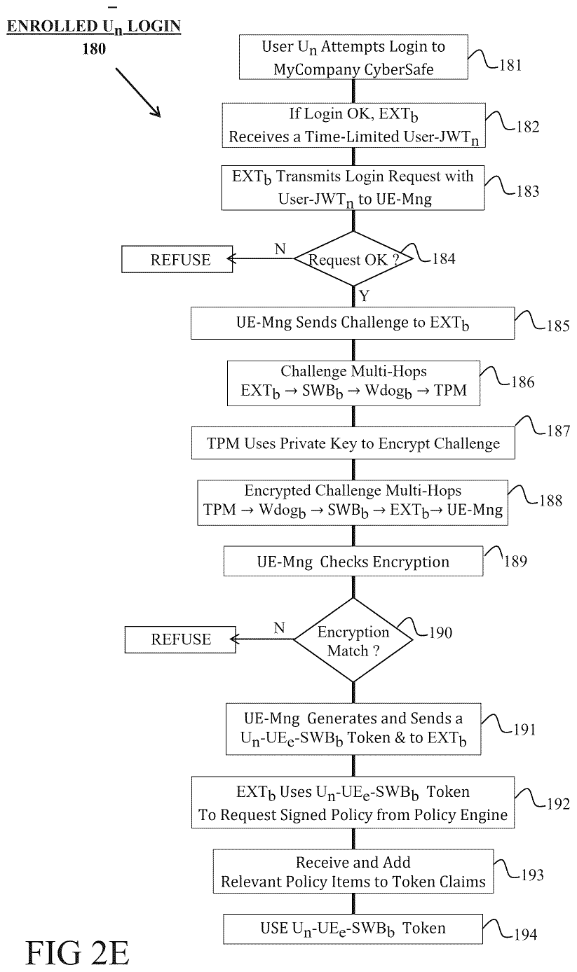

Flow diagrams presented in FIGS. 2A-2E show elements of procedures performed by a CyberSafe System and an SWB_{b}, such as CyberSafe system 50 and SWB 64, that exhibit and illustrate functionalities of the CyberSafe system and of the SWB_{b}, in accordance with an embodiment. The discussion assumes that the CyberSafe system provides cyber security services to a given MyCompany enterprise having a plurality of users Uₙ (1≤n≤N) identified by respective user IDs, U-IDₙ (1≤n≤N). The users are assumed to have access to and use user equipment identified by user equipment IDs, UE-IDₑ (1≤e≤E), and that CyberSafe has configured the UEs with CISEs and CyberSafe browsers, SWB_{b}, (1≤b≤B), identified by SWB browser IDs, B-DD_{b}.

FIGS. 2A-2C show a flow diagram 100 of a procedure by which a given user Uₙ using user equipment UEₑ contacts CyberSafe security hub 52 to request authorization to access and use CISE in UEₑ and have a resident SWB_{b} in CISE issued a security token for access to MyCompany resources.

In a block 102 user Uₙ operates UEₑ to sign in to CyberSafe security hub 52 and submit a request for the security token, the request comprising an Extended ID that optionally includes: the user ID, U-IDₙ; the user equipment ID, UE-IDₑ; and/or a SWB_{b} ID, B-ID_{b} that identifies the SWB installed in UEₑ. U-IDₙ may include the username, a password, and/or such data that associates the user with UEₑ, SWB_{b}, and/or MyCompany, such as a date at which the user was first registered or enrolled as a MyCompany user. UE-IDₑ may include any suitable identifier such as a MAC (media access) address, a UUID (Universal Unique Identifier), or an IMSI (international mobile subscriber identity), and/or information that associates UEₑ with user Uₙ, SWB_{b}, and/or MyCompany. The B-ID_{b} may include a browser user agent string, any suitable identifier that CyberSafe assigns SWB_{b}, and/or information that associates SWB_{b} with UEₑ, Uₙ, and/or MyCompany.

It is noted that a given user Uₙ may be associated with more than one UEₑ and/or more than one SWB_{b}, and the user ID U-IDₙ may comprise data that identifies the associations. Similarly, a given user UEₑ may be associated with more than one Uₙ and/or more than one SWB_{b}, and a given SWB_{b} with more than one Uₙ and/or more than one UEₑ, and the respective IDs, UE-IDₑ and B-ID_{b} may comprise data that maps the associations. Any combination of one or more of U-IDₙ, UE-IDₑ, and/or B-ID_{b} may comprise a Time of Day (ToD) for each of at least one previous sign in to CyberSafe.

Optionally, in a block 104 the CyberSafe Security Hub 52 authenticates the Extended ID. Authenticating the Extended ID may comprise engaging in a multifactor, optionally a three factor, authentication of user Uₙ and determining consistency of the associations and/or ToDs between any combination of two or more of U-IDₙ, UE-IDₑ, or B-ID_{b}.

In a decision block 106 if the Extended ID is not OK the hub proceeds to a block 142, denies the requested token, and optionally sends an alert of the refusal to the CyberSafe hub. On the other hand, if the Extended ID is OK the hub optionally proceeds to a decision block 108 to decide whether or not to run an integrity test on the SWB software. The decision to run or not to run an integrity test may depend on a MyCompany and/or CyberSafe testing policy. The policy may depend on when the CyberSafe hub ran a last integrity test on the SWB_{b}, and/or UEₑ, a user profile characterizing user Uₙ browsing behavior and internet use pattern, and/or a feature of a cyberattack landscape. For example, MyCompany may have a policy that a delay between integrity tests be no less than or greater than certain lower and upper bound delays. A decision may depend on whether user Uₙ browses to cyber dangerous websites listed in a list of dangerous websites at a frequency greater than a predetermined frequency or whether the user tends to be lax in updating passwords or patching applications. A cyberattack landscape may comprise frequency and/or severity of cyberattacks that have recently been experienced by MyCompany or other enterprises and/or what types of cyberattacks have been encountered. Optionally, if the decision in decision block 108 is to skip an integrity test, the hub proceeds to a block 140 and issues the desired token. If the decision in block 108 is to undertake an integrity test, the hub may proceed to a block 110 and retrieve from a database the hub comprises or to which the hub has access, a set, “SIT”, of at least one software integrity test, “sitᵢ”, where SIT={sitᵢ|1≤i≤I} that may be used to determine integrity of the SWB_{b} software. An exemplary SIT may comprise at least one, or any combination of more than one of:

$$\text{} \begin{matrix}{sit}_{1} = & CRT ( challenge response test ) ; \\ {sit}_{2} = & BAT ( behavioral attestation test ) ; \\ {sit}_{3} = & AV ( antivirus check ) ; \\ {sit}_{4} = & EDR ( endpoint detection and response ) ; \\ {sit}_{5} = & BDS ( binary digital signing ) ; \\ {sit}_{6} = & JSON feature detection ; \\ ⋮ & \\ {sit}_{I} & \end{matrix} \text{}$$

In a block 112 the CyberSafe hub determines a weight vector WIT comprising a weight witᵢ for each sitᵢ that provides an estimate for how appropriate the test sitᵢ is for determining integrity of the SWB_{b} software. In an embodiment a witᵢ for a given sitᵢ is a function of:
UEₑ hardware type, for example if the UEₑ is a mobile device, a tablet, or desktop which may limit what types of the given sitᵢ, may be performed on the UEₑ;
sensitivity, the true positive rate of the given sitᵢ;
specificity, the true negative rate of the given sitᵢ;
nuisance rating, which provides a measure of inconvenience performance of the test causes user UEₑ;
past performance of the test; and/or
a current cyberattack context, which identifies current prevalence and severity of cyberattack types.

In a block 114 CyberSafe hub runs a selection of tests sitᵢ on SWB_{b} software responsive to their respective weights witᵢ, for example where a greater weight wit; indicates greater relevance, by selecting integrity tests sitᵢ for which their respective weights are greater than a median weight witᵢ.

In a block 116 CyberSafe hub determines a value for a measure of a quality of integrity, QoI(e,b), for SWB_{b} software in UEₑ responsive to a measure of integrity returned by each of the selected tests sitᵢ. In an embodiment QoI(e,b) is an average of the measures of integrity provided by the sitᵢ weighted responsive to their respective weights witᵢ. Optionally, in a decision block 118 CyberSafe hub 52 determines if the QoI value is satisfactory or not. If the QoI is not satisfactory the hub proceeds to block 142 and denies issuing the token and optionally sends an alert. On the other hand, if the QoI is satisfactory the hub proceeds to a decision block 120 to determine whether or not to run ambient software environment tests on UEₑ.

Software environment tests are tests to determine to what extent, if at all, ambient software in UEₑ has been compromised by cyber damage or is insufficiently protected against cyber damage. The decision whether or not to perform the environment test on UEₑ may be based on many of the same considerations that are weighed when making the decision as to whether or not to perform integrity tests. For example, the decision may depend on MyCompany and/or CyberSafe policy and such factors as UEₑ hardware, for example whether the UEₑ is a mobile phone or laptop, when a last environment test was run on UEₑ, a browsing behavior pattern of user Uₙ, and/or a feature of a cyberattack landscape.

Optionally, if the decision in decision block 120 is to skip the software environment test, the CyberSafe hub may proceed to block 140 and issue the desired token. If on the other hand the decision is to undertake an environment test, the hub may optionally proceed to a block 122 and retrieve from a database a set “HVF(e)” of at least one cyberattack vulnerability feature hvf_{e,j} to be determined as present or absent, where HVF(e)={hvf_{e,j}|1≤j≤J}. HVF (e) may comprise static and/or dynamic vulnerability features. Static vulnerability features are features that are code and/or data elements comprised in the ambient software of UEₑ that are considered to render the ambient software and/or digital resources that are not comprised in the ambient software, such as CyberSafe and/or MyCompany resources, vulnerable to cyberattack. Dynamic vulnerability features are temporary vulnerability features, such as whether the UEₑ is connected to a public Wi-Fi or to a cyber dangerous website, that characterize a current use of UEₑ. An exemplary HVF(e) may comprise at least one, or any combination of more than one of vulnerability features whose presence or absence may be determined by response to, optionally, the following queries:

$$\text{} \begin{matrix}{hvf}_{e , 1} = & \begin{matrix}AV ( anti - virus ) / EDR ( Endpoint \\ Detection \& Response ) installed ? ;\end{matrix} \\ {hvf}_{e , 2} = & firewall installed and enabled ? ; \\ {hvf}_{e , 3} = & OS ( operating system ) patched to the latest version ? ; \\ {hvf}_{e , 4} = & applications patched to latest versions ? ; \\ {hvf}_{e , 5} = & access to {UE}_{e} require authentication ? ; \\ {hvf}_{e , 6} = & dangerous software defaults present ? ; \\ {hvf}_{e , 7} = & is public Wi - Fi being used ? ; \\ {hvf}_{e , 8} = & {UE}_{e} connected to a VPN ( virtual private network ) ? ; \\ {hvf}_{e , 9} = & security level of connected network ? ; \\ {hvf}_{e , 10} = & security misconfigurations ? ; \\ {hvf}_{e , 11} = & cross site scripting ? ; \\ {hvf}_{e , 12} = & erratic power provision ? ; \\ ⋮ & \\ {hvf}_{e , J} . & \end{matrix} \text{}$$

Optionally, in a block 124 CyberSafe hub scans the UEₑ ambient software environment to detect presence of each hvf_{e,j} and determine a risk vector HVR(e) comprising a cyberattack risk estimate hvr_{e,j} for each hvf_{e,j}, where HVR(e)={hvr_{e,j}|1≤j≤J)}. Determining a risk estimate for a given vulnerability hvf_{e,j} is generally dependent on the type of vulnerability and a cyberattack landscape. For example, determining a risk estimate for a given public Wi-Fi may be dependent on a physical location of the Wi-Fi, current traffic carried by the Wi-Fi at a time for which the estimate is made, and recent history of cyberattacks attempted via the Wi-Fi. Risks associated with patching may be a function of types of patching required or installed.

In a block 126 CyberSafe may scan UEₑ ambient software to determine a set HCC(e) of compromised components hccₖ in the ambient software, where HCC(e)={hcc_{e,k}|1≤k≤K}.

In a block 128 CyberSafe may retrieve from a CyberSafe and/or MyCompany database a user profile U-PRF(n) that may be used to characterize behavioral features of user Uₙ when interacting with MyCompany and/or non-MyCompany digital resources. In an embodiment U-PRF(n) comprises a set U-KPI(n) of key performance indicator (KPI) values for user key performance indicators ukpi_{n,k}, where U-KPI(n)={ukpi_{n,k}|1≤k≤K}, and a user cyber risk profile U-CRP(n) comprising values for user risk components ucrp_{n,r}, where U-CRP(n)={ucrp_{n,r}|1≤r≤R}. U-KPI(n) may include values for at least one, or any combination of more than one of: user keyboard typing patterns; user mouse activity patterns; user response time to digital resource actions, use of wrapped apps; use of shared secure services; data patterns used by the user during the session, including data typed locally in the SWB; files uploaded and downloaded, filenames; interruptions to use ambient software; and/or hover times at particular web pages. Values for U-CRP(n) components may include risk estimate values, optionally derived from U-KPI(n) component values, for at least one or any combination of more than one of: careless password management; careless permissions management; reckless clicking on actionable content; deficient sensitivity to phishing bait; or risk estimate for user abusing privilege to MyCompany resources.

In a block 130 CyberSafe processes HVR(e), HCC(e), U-PRF(n), and/or a set CPA(b) of values that provide measures of security that software, optionally referred to as cladding software or simply cladding, provides to protect the SWB_{b} from cyber damage to determine quality of the protection. Cladding may include any of various anti-injection and/or anti-exploitation software. Cladding may operate by way of illustrative example, to run additional security checks and install additional security controls, such as EDR (Endpoint Detection and Response), in order to allow a user with high privilege access to a MyCompany resource. Additionally, some capabilities that have impact on the system's vulnerability to cyberattacks may be constrained or disabled by cladding if the user is accessing an unknown website or a website with low security reputation and therefore high-risk. In an embodiment, a neural network is configured to operate on an input feature vector comprising component features based on components of HVR(e), HCC(e), U-PRF(n), and/or CPA(b) to determine the quality of protection.

Optionally, in a block 132 if the CyberSafe hub determines that the cladding protection is advantageous, the hub proceeds to block 140 and issues the requested token. If on the other hand the cladding protection is not advantageous, the hub may proceed to a block 134 to determine whether or not to amend the cladding protection to improve protection. If the hub decides not to amend, the hub may proceed to block 142 and deny the token and raise an alert. On the other hand, if the decision is to amend the cladding, the hub proceeds to a block 136, amends the cladding and optionally proceeds to a decision block 138 to determine if the amendment has resulted in sufficient improvement in cyber protection or not. If the improvement is not sufficient CyberSafe hub proceeds to block 142 and denies the token.

The process illustrated by flow diagram 100 assumes in block 102 that user Uₙ and UEₑ may have been registered, “enrolled”, by CyberSafe as a MyCompany user having an extended ID comprising at least one or any combination of more than one ID selected from a U-ID, UE-ID, and/or B-ID.

Flow diagram 150 illustrates a process by which CyberSafe may operate to enroll an unenrolled user Uₙ and unenrolled user equipment UEₑ and initiate their respective memberships as a MyCompany user and a MyCompany user equipment associated with data that may be used to provide an Extended ID and request a security token for access to MyCompany resources, in accordance with an embodiment of the disclosure. User Uₙ is assumed to have identifying data such as a user ID, U-IDₙ, and a user password, submitted to user management U-Mng 52.1 (FIG. 1) in CyberSafe hub 52 and stored in a Uₙ data record of a U-Mng database. And UEₑ is assumed to have identifying data, such as a user equipment ID, UE-IDₑ, submitted to user equipment management U-Mng 52.1 (FIG. 1) in hub 52 and stored in a UEₑ data record in a UE-Mng database.

In a block 151 user Uₙ boots-up UEₑ, which is assumed to have an installed CISE comprising an, SWB_{b} (an instance of SWB 64, FIG. 1), that includes an extension EXT_{b} (an instance of EXT 64.1), the CISE also having an installed at least one watchdog Wdog 72, Wdog_{b}, and a TPM 71 (see FIG. 1 for labeled icons representing installed CISE features). Upon booting up, in a block 153 watchdog Wdog_{b} optionally operates to vet integrity and proper operation of SWB_{b} and EXT. In an embodiment SWB_{b} may be configured to operate to check integrity and operation of Wdog_{b} and EXT_{b}, and EXT_{b} may be configured to operate to run integrity and operation checks on watchdog Wdog_{b} and SWB_{b}. Integrity and operation tests may by way of example, comprise any one or any combination of more than one integrity test discussed with respect to flow diagram 100. In an embodiment if an integrity check fails, EXT_{b} may abandon enrollment and alert the user to undertake remedial action to correct for the failure. In a decision block 155 EXT_{b} optionally determines if Uₙ and/or UEₑ are enrolled by CyberSafe, and if they are, abandons the enrollment process.

On the other hand, if extension EXT_{b} determines that Uₙ and/or UEₑ are not enrolled, EXT_{b} proceeds optionally to a block 157 and generates an enrollment request, which as indicated in a block 159, EXT_{b} transmits to the TPM, optionally via propagation through SWB_{b} and Wdog_{b}. In response to receiving the enrollment request, in a block 161 TPM generates a private/public key pair, and as indicated in a block 163 propagates the public key of the key pair to EXT_{b} optionally via Wdog_{b} and SWB_{b}.

Generation of the enrollment request and propagation of the public key to EXT_{b} may be transparent to user Uₙ, and in a block 165 the user attempts to login to CyberSafe by submitting to CyberSafe hub 52 user credentials, comprising a user ID, U-IDₙ, UE-IDₑ, and a user password, which credentials are received for processing by user management, U-Mng 52.1 (FIG. 1) in the hub. In a decision block 167 U-Mng authenticates, optionally in accordance with a multifactor authentication (MFA), the credentials. If authentication fails EXT_{b} abandons enrollment. On the other hand, if authentication is successful, in a block 169 U-Mng generates and provides EXT_{b} with a user token, optionally a User-JWTₙ (JSON word token), for user Uₙ. Optionally, in a block 171 EXT_{b} transmits the enrollment request, together with the User-JWTₙ and the public key generated by the TPM to user equipment UE management, UE-Mng 52.2 (FIG. 1).

In a decision block 173 UE-Mng checks the UE-Mng database to determine if it has a UEₑ data record and if data in the UEₑ data record and data payload in User-JWTₙ allows enrolling UEₑ as a MyCompany UE for user Uₙ. If enrollment is not allowed enrollment is abandoned. On the other hand, if enrollment is allowed, optionally in a block 175 UE-Mng stores the public key and any relevant data from User-JWTₙ in the UEₑ data record and in a block 177 determines that enrollment of Uₙ and UEₑ is successful and ends the enrollment procedure.

FIG. 2E shows a flow diagram 180 illustrating an enrolled user Uₙ attempting to login to MyCompany CyberSafe (FIG. 1) and gain access to MyCompany resources, in accordance with an embodiment of the disclosure. In a block 181 user Uₙ attempts to use UEₑ to login to MyCompany CyberSafe and in a block 182 U-Mng 52.1 (FIG. 1) authenticates the login and if authentication fails abandons the login and notifies the user of the failure. On the other hand, if the login is OK, U-Mng provides EXT_{b} with a time limited access token, optionally by way of example, a User-JWTₙ. In a following block 183 EXT_{b} operates to transmit a login request comprising the User-JWTₙ to CyberSafe hub 52 UE-Mng 52.2, which checks to authenticate the request. If the request does not satisfy authentication requirements, for example if the time-limit on User-JWTₙ has expired, in a decision block 184 CyberSafe refuses the login and prevents user access to MyCompany resources. On the other hand, if the request is OK, optionally in a block 185, UE-Mng 52.2 transmits a challenge to EXT_{b}, and in a block 186, EXT_{b} transmits the challenge to TPM, optionally via SWB_{b} and Wdog_{b}. In a block 187, TPM uses the private key of the key pair to encrypt the challenge and in a block 188 TPM transmits the encrypted challenge to UE-Mng, optionally via Wdog_{b}, SWB_{b}, and EXT_{b}.

In a block 189, UE-Mng uses the stored public key received in block 171 of flow diagram 150 shown in FIG. 2D to decrypt the encrypted challenge and determines if the decrypted challenge matches the challenge sent to TPM by UE-Mng in block 185. In a decision block 190, if the sent and decrypted challenges do not match, login fails and is refused. On the other hand, if the challenges match, in a block 191 UE-Mng generates a Uₙ-UEₑ-SWB_{b} Token comprising a data payload based on data and metadata included in the payload of User-JWTₙ and data from the UEₑ data record in the UE-Mng database and sends the token to EXT_{b}.

In a block 192 EXT_{b} uses the Uₙ-UEₑ-SWB_{b} Token to access Pol-Eng 52.3 (FIG. 1) and request a signed policy from the Pol-Eng that defines policy items that are relevant to interaction of Uₙ, UEₑ, and SWB_{b} with MyCompany and MyCompany resources. In a block 193 EXT_{b} receives the policy and stores policy items from the signed policy in at least one or any combination of more than one of the claims of the Uₙ-UEₑ-SWB_{b} Token, a data record in U-Mng, and/or a data record in UE-Mng. In a block 194 login to MyCompany CyberSafe, optionally subject to satisfying integrity and software checks in accordance with the procedure illustrated in flow diagram 100 is successfully completed and Uₙ-UEₑ-SWB_{b} Token is useable to access MyCompany resources.

In an embodiment EXT_{b} is configured to repeatedly initiate a vetting procedure of the identities of Uₙ, UEₑ, and/or SWB_{b} and integrity of software comprised in the UEₑ, and/or the SWB_{b}, after successful login indicated in block 194. Optionally, the vetting procedure comprises undertaking a challenge response procedure using the stored public and private keys and optionally performing an integrity and/or software check described with respect to flow diagram 100. In an embodiment performance of the vetting procedure may be periodic with a fixed period for example every 15 minutes or as otherwise determined responsive to an assessment of a UE or SWB software security risk or a feature of the user profile U-PRF(n) such as discussed above with respect to flow diagram 100. Rate of performance of vetting procedures may be time varying determined by a predetermined function, or stochastic for example as may be triggered by detection of a software anomaly, an anomaly in user behavior, and/or an event in an environment in which user Uₙ is operating.

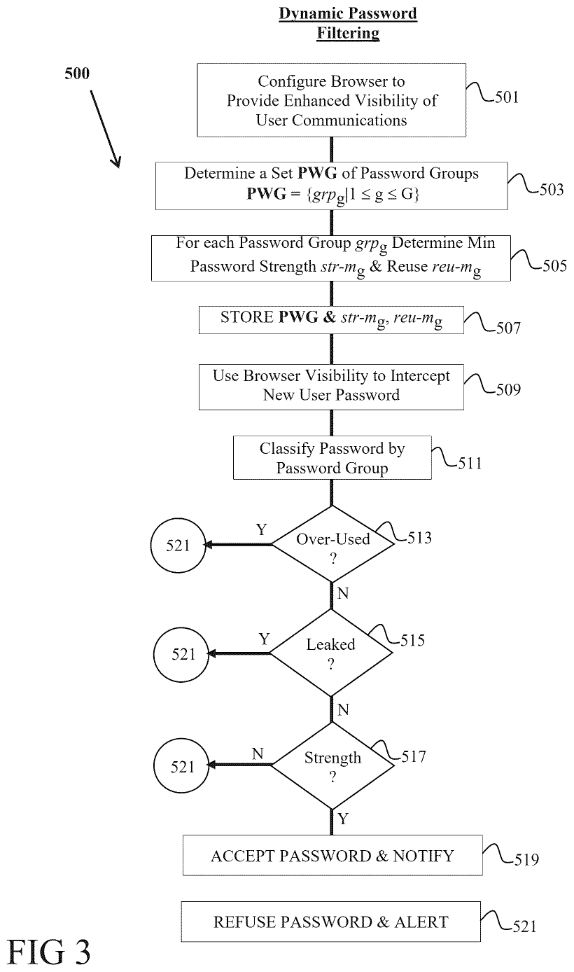

In an embodiment MyCompany and a MyCompany browser SWB_{b} may be configured to implement features of an algorithm, optionally referred to as “Dynamic Password Filtering”, for determining and vetting a new or modified password, or a new instance of a same password, generically referred to as a new password, before the new password is accepted by MyCompany for use by a user Uₙ. FIG. 3 shows a flow diagram 500 illustrating an embodiment of Dynamic Password Filtering. Implementation and/or support of a particular action or feature of Dynamic Password Filtering by a hardware and/or software element of CyberSafe may be referred to as being implemented or carried out by Dynamic Password Filtering or method 500.

In a block 501 browser SWB_{b} is configured, if not already configured, as discussed above to provide enhanced visibility of user communications by modifying browser code, in accordance with an embodiment of the disclosure. In a block 503 MyCompany determines a set PWG={grp_{g}|1≤g≤G} of password groups that are advantageous for associating passwords with different security constraints advantageous for protecting passwords used in different contexts. A PWG may comprise by way of example, a MyCompany IDP password group grp_{g} for: users based only on membership as a MyCompany user; each of a plurality of different MyCompany departments; each of a plurality of different MyCompany user security clearance (CLR) levels; each of a plurality of different MyCompany resource confidentiality (CON) levels characterizing resources to be accessed using passwords belonging to the group; each of a plurality of different cyberattack vulnerability assessments for MyCompany user equipment, UE, software configurations; MyCompany non SSO (single sign on) passwords; shared passwords; and/or user passwords that are not used for interacting with MyCompany.

Optionally, in a block 505 MyCompany determines for each password group grp_{g} a minimum value, str-m_{g}, for a measure of password strength that passwords belonging to the password group may be required to exhibit and optionally a maximum number, reu-m_{g}, of accounts for which the password may be reused.

A minimum value, str-m_{g}, for a password group may be determined as a constant or variable function based on any one or any combination of more than one of various relevant cyber security features, such as at least one metadata feature characterizing the password group and/or at least one feature of a user profile whose new password is classified as belonging to the password group. The at least one metadata feature may by way of example be at least one or any combination of more than one of a MyCompany department, a resource confidentiality, CON, level, and/or a user clearance level (CLR) common to passwords belonging to the password group. The at least one security relevant feature of a user profile may by way of example, be at least one feature or any combination of more than one feature of a user profile such as U-PRF(n) discussed above, a user role, a user CLR, and/or a frequency at which the user is expected to use the new password. It is noted that a cyber security relevant metadata feature characterizing a password group may also be a cyber security relevant user profile feature. For example, a password group may be defined for CLRs between predetermined lower and upper CLR bounds. A str-m_{g} for a new password for a given MyCompany user may be a function of the CLR bounds, and a value of a CLR level between the bounds that is assigned to the user, with the str-m_{g} having different values for different values of the assigned CLR level.

Similarly, a maximum reuse, reu-m_{g}, for the password group may be determined as a constant or variable function based on at least one or any combination of more than one of a relevant metadata feature and/or a feature of a user profile. For a password that is not allowed to be reused, reu-m_{g} is assumed to take on a value zero.

In an embodiment, in a block 507 the set of password groups, their respective associated metadata and str-m_{g} and reu-m_{g} constant or variable functions may be stored in a memory comprised in CyberSafe hub 52, MyCompany SWB_{b}, and/or CISE 62 (FIG. 1) suitable for supporting vetting new passwords generated using SWB_{b}, in accordance with an embodiment.

When a MyCompany user using SWB_{b} composes a new password, hub 52, and/or SWB_{b} uses browser visibility in a block 509 to view and intercept the new password for vetting before it is accepted for use. Optionally the password is intercepted for vetting before the browser transmits the new password to MyCompany for acceptance. In an embodiment the password is intercepted for vetting during composition of the password. Optionally in a block 511 hub 52, and/or SWB_{b} classifies the password to determine a password group grp_{g} to which the new password belongs. In accordance with blocks 513-519 MyCompany hub 52 and/or SWB_{b} alone or in cooperation vets the password to determine if the new password satisfies MyCompany policy standards.

In a decision block 513 the new password is vetted to determine if it has been or is expected upon acceptance to be overused by its reuse exceeding the reu-m_{g} associated with the determined password group grp_{g}. If it is determined to have been or is expected to be overused, Dynamic Password Filtering proceeds to a block 521 to refuse the password and alert the user to provide an alternative new password. If on the other hand the new password is determined not to be or not expected to be overused, Dynamic Password Filtering proceeds to a decision block 515 to determine if the new password has been leaked. Any of various databases listing passwords that are considered to have been leaked may be searched to determine if the new password has been leaked. In an embodiment the new password may be considered to have been leaked if a measure of a distance, optionally referred to as an edit distance, between the new password and another password known to be or to have been in use is less than a predetermined distance. The edit distance may be determined based on any of various edit distances, such as by way of example, a Levenshtein distance, a Hamming distance, and/or a cosine distance. If in decision block 515 the new password is determined to have been leaked Dynamic Password Filtering proceeds to block 521, refuses the password and alerts the user to the refusal.

On the other hand, if the new password is determined not to have been leaked, Dynamic Password Filtering may proceed to decision block 517 to determine if the new password is characterized by a password strength greater than or equal to str-m_{g}. If the new password strength is less than str-m_{g} Dynamic Password Filtering proceeds to block 521 to refuse the password and alert the user. If the password strength is determined to be greater than or equal to str-m_{g} Dynamic Password Filtering accepts the new password and notifies the user of the acceptance in a block 519.

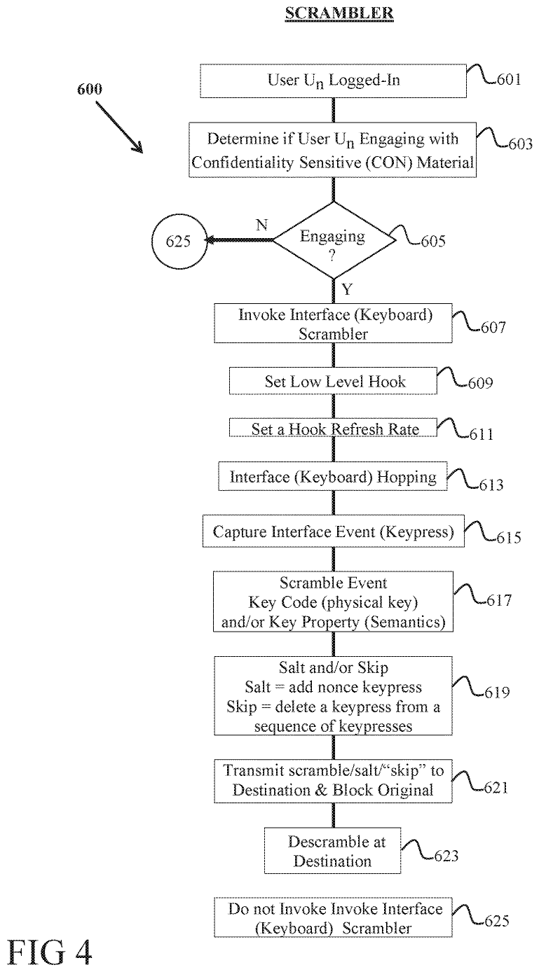

FIG. 4 shows a flow diagram 600 illustrating a scenario in which a CyberSafe method, optionally referred to as a data stream Scrambler or simply Scrambler, operates to obfuscate a data stream generated by a user operating a human-computer interface (HCI), such as a real or virtual UE keyboard or mouse, in accordance with an embodiment of the disclosure. In the discussion implementation and/or support of a particular action or feature of Scrambler by a hardware and/or software element of CyberSafe may be referred to as being implemented or carried out by CyberSafe, Scrambler, or method 600. For convenience of presentation, it is assumed that the HCI is a real keyboard.

In a block 601 a MyCompany user Uₙ is logged-in to MyCompany and has access to and is using a MyCompany browser SWB_{b} of a UEₑ to interact with a MyCompany resource in accordance with an embodiment. In a block 603, optionally SWB_{b}, determines if the interaction involves or is liable to involve the user engaging with confidentiality sensitive, CON, material also referred to as confidentiality sensitive, CON, features. Confidentiality sensitive material comprises any material that is considered by MyCompany to advantageously require limiting exposure and/or distribution to MyCompany users based on user security clearance, CLR, levels. CON material may by way of example comprise user passwords, proprietary information such as trade secrets, intellectual property, and/or business strategies. CON and CLR levels may by way of example be determined responsive to consideration by MyCompany personnel or by using an artificial intelligence (AI), for example a machine learning algorithm, such as a decision tree or clustering algorithm, or a convolutional neural network (CNN), educated by supervised and/or unsupervised learning.

For convenience of presentation, it is assumed by way of example that CON and CLR levels have numerical values that span a same numerical range. It is further assumed that MyCompany material having greater confidentiality sensitivity is assigned CON levels higher than CON levels assigned to material having lower confidentiality sensitivity. And it is assumed that users assigned greater CLR levels have access to material having CON levels higher than CON levels of material to which users assigned lower CLR levels have access.

In an embodiment determining whether the user is engaging with or liable to engage, generically “engage”, with CON material may be based on a CON level of the material and/or a CLR level of the user. For example, a user may be determined to be engaging with CON material if the material has a CON level greater than a predetermined level. A user may be determined to be engaging with CON material if the user has a CLR level greater than a predetermined upper threshold CLR level or less than a predetermined lower threshold CLR level. Alternatively, or additionally, a user may be determined to be engaging with CON material as function of a difference between a CON level of the material and a CLR level of the user. For example, if a difference between the user CLR level and the CON level of material to which the user is allowed access by MyCompany policy is less than a predetermined difference, the user may be determined to be engaging the CON material. The user may be determined to be engaging with CON material if user interaction with MyCompany resources is or is liable to be compromised by any of the cyber risks discussed with respect to flow diagram 100 (FIG. 2A-2C). In an embodiment an artificial intelligence (AI) may be used to process feature vectors comprising components that are values of a selection of the aforementioned CON, CLR, and risks factors to determine when and how to determine that a user is engaging CON material.

In a decision block 605, if the user is determined not to be, or not liable to be engaging in MyCompany CON material CyberSafe optionally advances to a block 625 and abandons scrambling. On the other hand, if the user is determined to be engaging CON material, CyberSafe continues optionally to a block 607 to invoke Scrambler. In a block 609 Scrambler sets a low-level hook for the HCI, which as noted above is assumed to be a real keyboard of the UEₑ. Optionally, the low-level hook is set to intercept keypress scan codes that the keyboard microprocessor generates responsive to key presses, or keypress virtual codes that comprise a key-code and a key-property which a keyboard driver of the UEₑ operating system generates responsive to the scan codes. Optionally in a block 611 the Scrambler determines a refresh rate for the keyboard hook to maintain priority of the hook with respect to a possible later keyboard hook that might be set by a cyber intruder. The refresh rate may be dependent on CON and/or CLR levels, and/or any of the risk factors discussed with respect to flow diagram 100 (FIG. 2A-2C).

In a block 613 Scrambler may institute HCI hopping. HCI hopping comprises alerting a user to optionally repeatedly, optionally periodically, or in response to a stochastic prompt, to switch from a first HCI to a second HCI to which the user has access to interact with a MyCompany resource. The HCIs may be real, bare metal, or virtual HCIs. For example, Scrambler may prompt the user to switch from keying in a new password using the assumed real keyboard of UEₑ, which for example may be a laptop or desktop, to a smartphone virtual keyboard or between two or more virtual keyboards presented on the laptop or desktop screen, or on a plurality of screens presented on different UEs. The decision to institute interface hopping and determine a mode of hopping that defines a frequency of hopping and sequence of hopping between different HCIs, may be based on the same considerations on which a decision to invoke Scrambler and/or set a hook refresh rate is based.

In a block 615 the user presses a key on the real keyboard and the Scrambler captures the keypress event by operation of the hook, optionally as a keypress virtual code comprising a key code and a key property, and in a block 617, optionally, scrambles the virtual code. Scrambling the virtual code comprises changing the key code and/or the key property to provide a changed virtual code representing a keypress different from the one actually pressed. And in a block 619 Scrambler may salt or skip the changed or original, unchanged virtual code, in the event that Scrambler did not change the original virtual code in block 617. Salting the changed or unchanged virtual code comprises adding an additional, at least one nonce virtual code to the virtual code so that the virtual code is converted to a plurality of virtual codes of which at least one is a nonce code. Skipping the changed or unchanged virtual code means to an extent possible isolating the code so that it appears as if the keypress that generated the code did not happen or is unknown. For a sequence of virtual signals corresponding to a sequence of keypresses a skipped keypress may be replaced by a null or empty virtual code signal, or an absence of a virtual code signal between two transmitted virtual code signals. A changed, salted or skipped virtual code in place of an original virtual code may be referred to as a scrambled code.

In an embodiment, optionally in a block 621 Scrambler blocks the original, unchanged virtual code from being propagated to the original virtual code's destination application and transmits the scrambled virtual code to the intended destiny application for processing. Blocking may be achieved by software or by activating proprietary hardware preinstalled in the keyboard. In a subsequent block 623 the destination application unscrambles the scrambled virtual code to recover the original virtual code and thereby determine the corresponding original keypress. In an embodiment the destination application uses an unscrambling key, for example in the form of a lookup table (LUT) to unscramble scrambled virtual codes. In an embodiment the unscrambling key is provided by CyberSafe and/or by Scrambler, prior to invoking the Scrambler. In a block 623 the destination application uses the unscrambling key to unscramble the scrambled virtual code and recover the original virtual code from which the scrambled virtual code was scrambled and thereby determine the corresponding original keypress.

It is noted that whereas the above description assumes that the HCI is a keyboard, practice of an embodiment of the disclosure is not limited to keyboards. For example, a Scrambler in accordance with an embodiment may operate similarly as described above to scramble and obfuscate communications transmitted to a destination application by a mouse or a gesture recognition system.

In an embodiment CyberSafe leverages the enhanced visibility that MyCompany SWBs provide for monitoring user communications and web browsing to acquire data relevant for profiling MyCompany users, MyCompany resources, and entities such as websites, smart phones, and internet of things (IoT) with which the users communicate and interact. In an embodiment, the profiling data is used to enhance sensitivity of CyberSafe for detecting risk of cyber damage to MyCompany resources and/or leak of MyCompany data, optionally from or a result of phishing attacks, that may arise from user web browsing activity. In an embodiment, the increased sensitivity is used to provide, optionally real-time, dynamic protection against phishing incursions during user website browsing activity.

In an embodiment the profiling data may be represented by a multiplanar graph optionally comprising a user plane that has a graph of MyCompany users, a resource plane that has a graph of MyCompany resources, and an interlocutor plane that has a graph of interlocutor entities with which MyCompany users may communicate and interact and may be or serve as attack surfaces. Interlocutor entities may for example comprise, computers, mobile devices such as smartphones, wearables such as smart watches, routers, Internet of Things (IoT) devices, security cameras, medical devices and websites. For convenience of presentation the interlocutor entities are assumed to be websites and the interlocutor plane referred to as a website plane.

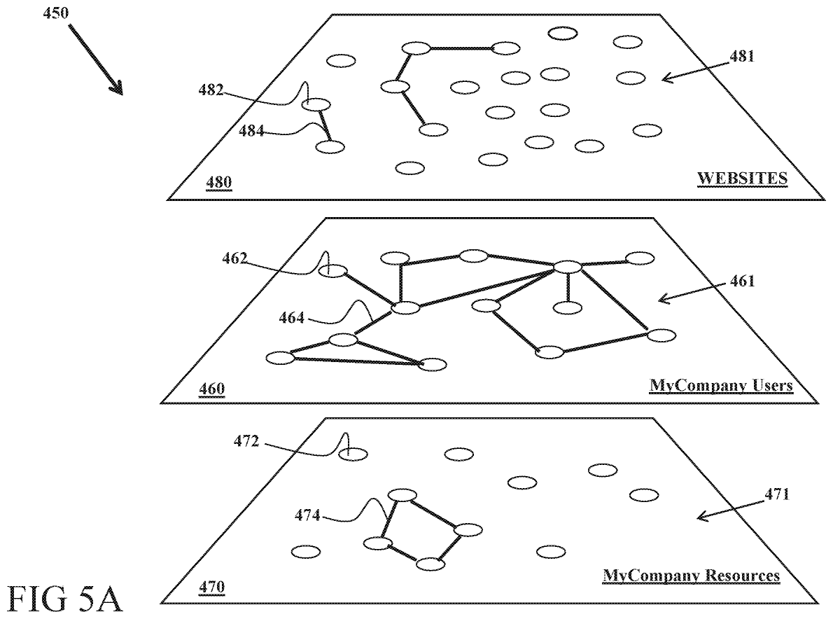

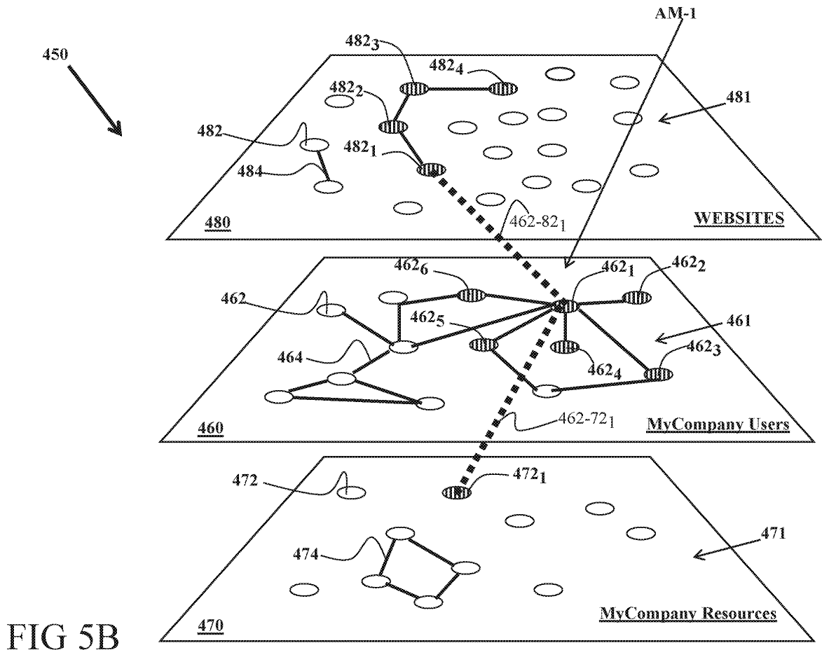

FIG. 5A schematically shows and illustrates features of a multiplanar graph 450 comprising a user plane 460 having a user graph 461, a resource plane 470 having a resource graph 471, and a website plane having a website graph 481.

User graph 461 comprises user nodes 462 and user edges 464. The user nodes represent different MyCompany users Uₙ. The user edges represent interactions between the users. Each user node is associated with a set of features considered to be comprised in a user feature vector that identify and characterize the user Uₙ that the node represents. The user feature vector for a given user Uₙ may be and/or comprise in whole or in part user profile U-PRF(n) as discussed above with respect to flow diagrams 100 (FIGS. 2A-2C) and optionally additional user characterizing features such as those discussed with respect to flow diagram 500 (FIG. 3). The user feature vector may also comprise features identifying and characterizing a particular UEₑ and SWB_{b} that user Uₙ uses to browse and/or communicate.

For example, identifying features of the user feature vector may comprise identifying features discussed with respect to U-PRF(n), and may include user metadata having in addition to a user ID, U-IDₙ, for user Uₙ, a MyCompany department to which given user Uₙ belongs, and various indicators of the user's position in MyCompany, such as a title and a role, and/or a clearance level, CLR, for the user that determines for which MyCompany resources the user is permitted access. Characterizing features may comprise features that indicate the user's social interaction with other MyCompany users, such as for example an influence score, a network centrality, and/or a gatekeeper index. Characterizing features may comprise as discussed above with reference to U-PRF(n), a set U-KPI(n)={ukpi_{n,k}|1≤k≤K} of values for user key performance indicators ukpi_{n,k}, and a user cyber risk profile U-CRP(n)={ucrp_{n,r}|1≤r≤R} comprising values for user cyber risk components ucrp_{n,r}.

User edges 464 may indicate and be used to identify not only with which other users a given user Uₙ interacts, but also types and intensities of the interactions. For example, a user edge 464 connecting the given user Uₙ with another user may be a symmetric or directed edge indicating a symmetric or one-way interaction respectively between Uₙ and the other user. Additionally, or alternatively, the edge may be used to characterize frequency of interactions and/or a type of interaction. A type of interaction may for example be a social interaction, or a spoken or email information exchange involving one or more of a particular class of data such as research and development data, financial data, marketing data, and/or management data. It is noted that whereas in FIG. 5A a pair of nodes 462 is shown connected by only one edge, a pair of nodes may be connected by a plurality of edges, of which each edge represents a relationship distinguished from relationships represented by others of the plurality of edges. Data identifying and characterizing a particular user edge may be considered to be features comprised in a user edge data record, optionally referred to as a user edge feature vector, associated with the user edge.

Resource graph 470, comprises resource nodes 472 and resource edges 474. Resource nodes represent different MyCompany resources of a set RSRC={rsrc_{c}|1≤r≤C} of resources rsrc_{c}, and resource edges 474 represent relationships between the resources. Each resource node is associated with a set of features considered to be components of a resource feature vector having data that identifies the resource which the node represents and data that characterizes the resource. As in the case of user nodes and edges, a pair of resources may be connected by more than one resource edge.

Resource identifying data may comprise metadata such as a resource ID, a date at which the resource was created, a last update date, and/or authors of the resource. Characterizing data may comprise, a type of data communication medium for example, textual, image, audio, and/or mixed media data comprised in the resource, and classes of subject matter, such as software, financial, marketing, and/or human resource (HR) material that the resource comprises. Resource characterizing data may also comprise a rate at which MyCompany users access the resource, download the resource or data from the resource, a listing of which MyCompany users access the resource, a confidentiality (CON) level for material the resource comprises, and/or a degree of protection against cyber-tampering that the resource enjoys.

Resource edges 474 between resource nodes 472 may indicate symmetric or asymmetric relationships, and may by way of example, represent a commonality of metadata, such as content, authors and/or a measure of reliability that nodes share, and/or a number of times user access to one resource represented by a node of a pair of nodes leads to the user accessing the resource represented by the other node of the pair of nodes. Features comprising data identifying and/or characterizing a particular resource edge may be considered to be features comprised in a resource edge feature vector.

Website graph 480, comprises website nodes 482 that represent different websites of a set WS={ws_{W}|(1≤w≤W)} of websites ws_{W}, and website edges 484 that represent relationships between the websites. Each website node is associated with a set of features that identify a particular website ws_{W} and characterize the website and interaction of the website with other websites and MyCompany users. The features are considered to be components of a website feature vector.

Website characterizing features may comprise a set WRV(w)={wrv_{W,V}|1≤v≤V)} of website cyber risk indicators wrv_{W,V} that represent measures of cyber-risk to which MyCompany may be exposed by browsing access to the website. Website cyber risk indicators may comprise a website reputation, a listing in any of various “cyber-dangerous” website blacklists, such as a phishing and malware blacklist, and/or a list of websites known to have distributed malware. The risk indicators may also include indicators of excessive pop-ups and/or adds, excessive or unsolicited redirects, suspicious links, anomalous URLs, and/or surprising and/or poor-quality design features. Website edges 484 may represent redirects between websites represented by nodes and/or frequency of redirects between nodes, commonality of subject matter that websites share, frequencies of data transfer between nodes, and/or cyber-risks that two websites share or may cooperate to generate.

The feature data, optionally referred to as graph data, associated with and represented by the nodes and edges of layers 460, 470, and 480 of multiplanar graph 450 may be stored in any suitable memory that provides access to the graph data to support operations of CyberSafe, MyCompany, MyCompany hub, and/or browsers SWBs in protecting MyCompany resources from cyber risks.

In accordance with an embodiment, the graph data is used to protect a user Uₙ and MyCompany against phishing risks when the user uses a browser SWB_{b}, optionally to access websites.

For example, in accordance with an embodiment when a given user Uₙ logs in to MyCompany to conduct user activity using a MyCompany browser SWB_{b}, the browser may determine to monitor the user's actions that the given user performs using the browser. In an embodiment, during monitoring when the given user communicates directly or indirectly with one or more other users represented by nodes 462, one or more company resources represented by nodes 472, and/or one or more websites represented by nodes 482, the browser generates an activity group. The activity group lists the given user, the other users, resources, and websites, generically referred to as interacting entities, with which the given user Uₙ is directly or indirectly interacting.

The activity group may be represented by nodes representing the interacting entities, planar edges connecting the nodes in a same plane of multiplanar graph 450, and interplanar edges, represented by dashed lines, that connect nodes from different planes. Two interacting entities are considered to be directly interacting if their respective nodes in multiplanar graph 450 are connected by an edge. Two interacting entities are considered to be indirectly interacting if their respective representative nodes are connected by a plurality of edges, none of which connect the two nodes. The representation of an activity group by nodes and edges in multiplanar graph 450 may be referred to as an activity map.

FIG. 5B schematically shows an exemplary, schematic activity map, AM-1, that browser SWB_{b} generates responsive to monitoring activity of a user Uₙ represented by a node 462₁ in multiplanar graph 450 and detecting that the user has accessed and is directly interacting with a MyCompany resource represented by a resource node 472₁ in resource plane 470, and a website represented by a website node 482₁ in website plane 480. In FIG. 5B the interaction of user 462₁ with resource 472₁ is represented by an interplanar edge 462-72₁ in multilayer graph 450 and the interaction of user 462₁ with website 482₁ is represented by an interplanar edge 462-82₁. For convenience of reference, nodes representing interacting entities in the activity group represented by activity map AM-1 are shown patterned with a bar pattern.

In accordance with an embodiment, for the purpose of detecting a possible risk of a phishing attack and data leak, SWB_{b} may be configured to include in an activity group and corresponding activity map generated for user 462₁, users that are indicated by data in their respective user feature vectors and user edge feature vectors of user graph 464 to directly and/or strongly interact with user 462₁. Therefore, as indicated by the patterned nodes in FIG. 5B, AM-1 includes user nodes 462₂-462₆. Similarly, browser SWB_{b} may be configured to include in the activity map in addition to website 482₁ with which user 462₁ interacts directly, a selection of websites that are strongly connected, directly and/or indirectly, to the given website as may be indicated by graph data in website feature vectors of website edges. Therefore, as indicated by the patterned nodes in website plane 480, AM-1 includes website nodes 482₂-482₆.

In accordance with an embodiment, to determine a phishing data loss risk for browsing activity of user 462₁ as modelled by activity map AM-1, browser SWB_{b} generates an activity map feature vector for the activity map. Optionally, the activity map feature vector comprises a concatenation of features from the feature vectors associated with the users, resources, websites, and relationships represented by the nodes and edges included in activity map AM-1.

The activity map feature vector may also include time dependent, dynamic interaction features for an interacting entity represented in activity map AM-1. Dynamic interaction features of an activity group are based on data generated by and characterizing activity of an interacting entity of the activity group during activity of the group. A MyCompany SWB and/or the CyberSafe hub may generate a dynamic interaction feature for inclusion in an activity map feature vector for the activity group responsive to detecting an anomaly in behavior or configuration of an interacting entity of the activity group, that is monitored by the SWB. For example, the SWB and/or CyberSafe may be configured to undertake real-time image processing of webpages presented to users in the activity group to identify cyber risk anomalies in the images and generate dynamic interaction features responsive to the anomalies. The browser and/or hub may generate dynamic interaction features responsive to detecting changes in variables characterizing interacting entities that are greater than predetermined upper limits for such changes. For example, the browser and/or hub may generate a dynamic interaction feature responsible for reckless clicking on actionable content, unusual hover times at particular web pages, and/or a website exhibiting excessive pop-ups or prompts to download software or causing inordinate slowing operation of the SWB.

In an embodiment, the activity map feature vector is processed, optionally in real-time, by an artificial intelligence (AI) configured by supervised and/or unsupervised training to provide a probability that an interacting entity of an activity group modelled by an activity map, such as by way of example AM-1, will result in damage from phishing. In an embodiment the AI comprises a deep neural network. Optionally, the DNN comprises a graph convolutional neural network (GNN). Optionally the GNN comprise at least one or any combination of more than one of a graph convolutional neural network (GCN), a graph attention network (GAT) and/or a graph recurrent neural network (GRNN). Optionally, CyberSafe hub and/or the SWB are configured to generate a probability heat map responsive to probabilities provided by the AI for the activity group to indicate contributions made by interacting entities of the activity group to the probability of causing cyber damage to MyCompany from phishing.

In an embodiment CyberSafe may undertake action, optionally in real-time, to prevent or mitigate cyber damage indicated by probabilities provided by the AI. For example, for the instance of AM-1 shown in FIG. 5B, CyberSafe may shut down the browsing session of user 462₁, prevent the user from communicating with other users in the activity group, prevent user 462₁ from uploading or downloading material to or from one or more of websites 482₁-482₂ and/or resource 472₁ and/or reconfigure material on a webpage generated by SWB_{b}.

In an embodiment, to mitigate or prevent cyber damage in real time, CyberSafe and/or the SWB_{b} may be configured to display the heatmap generated for AM-1 to user 462₁ to visually alert the user to the determined probability of and responsibilities for potential cyber damage determined by the AI. The displayed heat map may also be configured to indicate which interacting entity or entities and/or relationship/s modelled in the probability heat map for the activity group may best be addressed to prevent the damage. Optionally CyberSafe and/or the SWB_{b} provides the user with a selection of suggested remediating actions that may be undertaken to prevent the damage. Suggested remediating actions may include at least one or any combination of more than one of: quarantining an interacting entity, limiting transfer of information to and from a particular entity, reconfiguring an entity and/or a relationship between interacting entities. The remediating actions and best addressed entities and relationships are optionally presented in a table appended to the heat map.

In an embodiment CyberSafe may update graph data logged into a CyberSafe database responsive to probabilities provided from processing the activity map feature vector. For example, if the probability heat map indicated that a particular website 482₁-482₄ is responsible for a large probability of risk, CyberSafe may downgrade a reputation of the website. If activity of user 462₁ is indicated as being inordinately responsible for a probability of cyber risk, MyCompany may change permissions, or lower a CLR level granted to the user.

In an embodiment the accumulated graph data and heat maps may be used to generate material for educating and sensitizing users to phishing attacks and testing users to determine their ability to avert phishing attack. For example, the material may comprise virtual or real phishing attack scenarios, each scenario accompanied by a selection of possible actions from which a user may select a best action to undertake to prevent damage resulting from the attack scenario. A user proficiency in averting phishing attack may be determined by a measure of how often the user selects a best action. The user proficiency in dealing with phishing attacks may be improved by the user practicing responding to the scenarios.

It is noted that whereas the above description relates to cyber risks caused by phishing, practice of an embodiment of the disclosure is not limited to phishing. Methods in accordance with an embodiment of the disclosure are applicable with appropriate modifications to identify and protect against a variety of cyber risks and may by way of example, be used to determine and moderate cyber risks from injection of malicious scripts, Trojan horses, and insider threats.

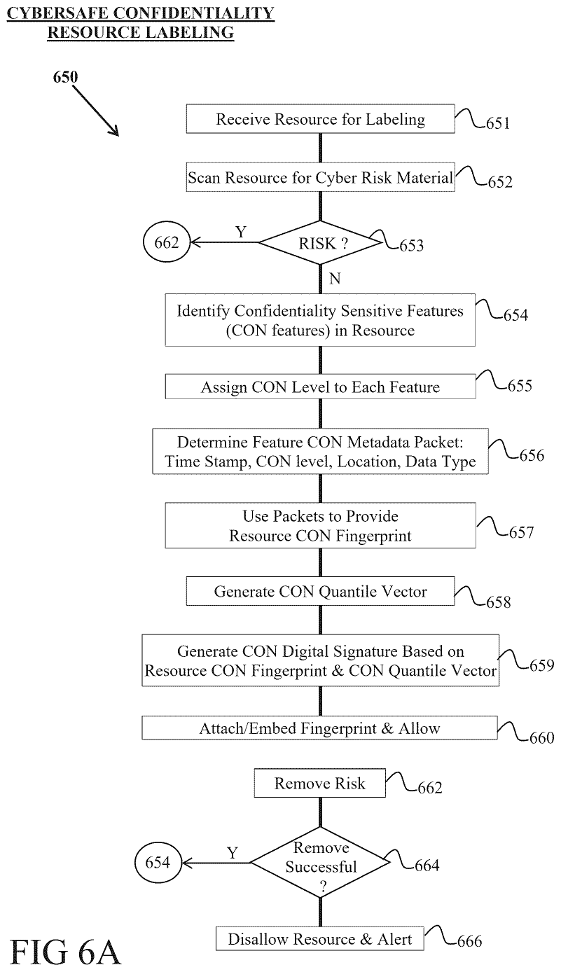

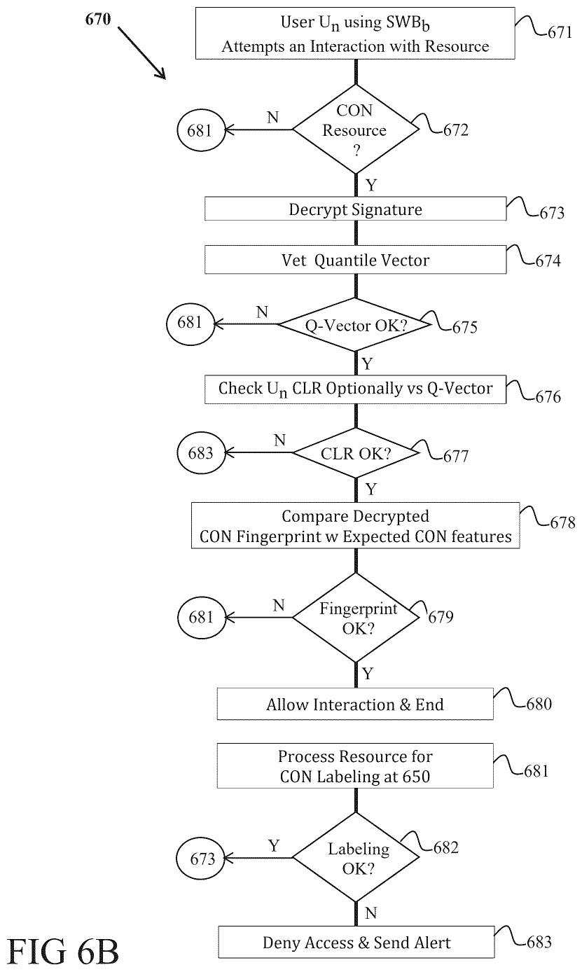

In accordance with an embodiment of the disclosure, CyberSafe, MyCompany, and/or SWB_{b} may operate on their own or cooperate to label MyCompany resources with confidentiality, CON, levels that may be used to control access to and motion of the resources. In an embodiment labeling comprises generating a CON digital signature based on a resource CON fingerprint and/or a CON quantile vector, in accordance with a resource confidentiality labeling process, optionally as described in a flow diagram 650 shown in FIG. 6A. The process may be referred to as a RECON process or simply RECON. An action carried out by the CON labeling process by any software and/or hardware component of CyberSafe, MyCompany, and/or SWB_{b} may be referred to as carried out by RECON. Use of CON digital signatures in accordance with an embodiment is illustrated by a flow diagram 670 shown in FIG. 6B.

In a block 651 RECON receives a given resource for labeling and in a block 652 scans the resource for cyber risk material the resource may contain. In a decision block 653 if the resource does not comprise risk material RECON may proceed to a block 654.

In block 654 RECON scans the given resource to identify confidentiality sensitive features, CON features, in the resource and in other resources that may be accessed via hyperlinks comprised in the given resource. Modern digital resources are often complex resources that may, they themselves and/or via hyperlinks to other resources, comprise text, image, audio, and/or video, data. Reference to a CON feature is considered a generic reference a CON feature that may be based on and/or include, text, image, audio, and/or video, data. A CON feature of a given resource may be located in the given resource and/or a hyperlink resource accessed via a hyperlink from the given resource.

Optionally in a block 655 RECON assigns a CON level to each identified CON feature, and in a block 656 determines a feature CON metadata packet. In accordance with an embodiment the metadata packet comprises a time stamp for a time at which the packet is assembled, the CON level for each CON feature identified in the given resource, location of the CON feature in the resource, and a class of data with which data in the resource is associated. In a block 657 RECON assembles a resource CON fingerprint which includes all or a selection of the CON metadata packets. The CON fingerprint may be configured as a feature vector comprising the metadata packets concatenated, optionally in an order in which they appear in the resource.

Optionally in a block 658 RECON generates for the resource a CON quantile vector comprising CON quantile values for a set of quantiles of a distribution of CON values assigned to the CON features identified in the resource. In a block 659 RECON generates a digital signature based on the resource CON fingerprint and the CON quantile vector. In a block 660 RECON embeds or attaches the digital signature to the resource.

If in decision block 653 the given resource is determined to comprise cyber risk material RECON optionally advances to a block 662 and operates to remove the material. In a block 664 if RECON is successful in removing the material RECON returns to block 654 to process the resource and in block 660 provide the resource with a CON fingerprint and allow use of the resource by MyCompany users. If on the other hand removal is unsuccessful RECON advances to a block 666, disallows use of the resource and generates an alert notifying of the disallowance.

In a block 671 of flow diagram 670 shown in FIG. 6B a user Uₙ using a MyCompany SWB_{b} attempts to interact with an optionally MyCompany resource wherein interacting with a resource comprises any user action that puts the resource in motion, for example, downloading, uploading, modifying, and/or transmitting to another user. In a decision block 672 browser SWB_{b} operates to vet the resource and determine if the resource is a confidentiality sensitive, a CON, resource.

If in a decision block 672 the resource is a CON resource, RECON proceeds to a block 673 to decrypt the digital signature associated with the resource and optionally in a block 674 checks the CON quantile vector, also referred to as a CON Q-vector or simply Q-vector, decrypted from the signature against a Q-vector expected for the resource. In a decision block 675, if the decrypted Q-vector agrees with the expected Q-vector, RECON may check the user clearance level, CLR, in a block 676 to determine if the user has clearance to access the resource. Checking the user CLR optionally comprises determining if CLR is greater than or equal to a threshold quantile value in the Q-vector. For example, checking CLR may comprise checking CLR against a threshold CON quantile value for which 80% of the CON levels assigned in block 655 of FIG. 6A are less than the threshold quantile value.

Optionally in a decision block 677 if the CLR level is not equal to or greater than the threshold quantile value, RECON may proceed to a block 683 and deny user interaction with the resource and alert the user and/or MyCompany to the denial. On the other hand, if in decision block 677 CLR is equal to or greater than the threshold quantile value, RECON may proceed to a block 678 and compare the CON fingerprint (FIG. 6A, blocks 654-657) decrypted from the signature to determine if it matches an expected CON fingerprint. Comparing optionally comprises comparing values comprised in CON metadata packets determined for CON features comprised in the decrypted fingerprint to determine if the values match with values comprised in corresponding CON metadata packets in the expected CON fingerprints. In a decision block 679 if the comparison is successful and the decrypted and expected fingerprints match RECON optionally proceeds to a block 680 to allow the user to interact with the resource.

In decision blocks 672, 675, and 679 if the requirements in the blocks are not met RECON optionally proceeds to a block 681 to process the resource in accordance labeling procedure 650 shown in FIG. 6A to determine whether or not to provide the resource with a CON digital signature. In a decision block 682 if the labeling procedure fails and the resource is not provided with a digital signature RECON proceeds to block 683 to deny user interaction with the resource. On the other hand, if labeling succeeds RECON returns to block 673 to determine whether to grant the user interaction with the resource.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

### System and Method for Secure Data Handling Based on File Sensitivity

This section relates to a secure data handling system designed to address the challenges associated with managing files of varying sensitivity levels. The goal is to introduce the Talon Secure Browser File Sensitivity Engine, a solution aimed at safeguarding proprietary information, intellectual property, and sensitive data from inadvertent or intentional leakage. By leveraging the Talon engine, which can be an internal, AI-based, or third-party engine, the system identifies and validates file sensitivity labels, thereby ensuring data integrity. In case of label-file mismatches, the system enacts predefined policy-based actions, such as blocking file uploads, downloads, or openings, as set by the Talon administrator (but not limited to these actions only).

### BACKGROUND

In various organizational settings, handling files with different levels of sensitivity poses significant challenges. Leakage of sensitive data, whether intentional or accidental, can lead to severe consequences. Talon Secure Browser File Sensitivity Engine addresses these issues by introducing a secure data handling system.

### Talon Secure Browser File Sensitivity Engine

Talon Secure Browser File Sensitivity Engine which may be an internal proprietary engine, an AI-based engine, or a third-party engine, will effectively manage and scan for file sensitivity levels.

### Handling Microsoft Information Protection (MIP) Sensitivity Labels or Similar Tools/Sensitivity Labels:

Talon caters to customers who utilize Microsoft Information Protection (MIP) sensitivity labels or similar mechanisms. The Talon engine identifies and validates file sensitivity labels, ensuring that the actual file content aligns with the designated label. In instances of label-file mismatches, predefined policy-based actions, as established by the Talon administrator, are promptly implemented. These actions may include blocking file uploads, downloads, openings, events etc.

Handling Customers without any Sensitivity Label Tools:

For Talon customers without sensitivity label tools or limited labeling, the Talon engine extends its capabilities to various file actions, such as file downloads, uploads, or openings. The engine effectively acts on files that contain sensitive information. Policy-based actions, defined by the Talon administrator, are enforced when sensitive documents are accessed. Such actions may involve blocking file operations or triggering relevant events as per the Talon administrator's settings.

In summary, the Talon Secure Browser provides a comprehensive solution for managing files of different sensitivity levels. By incorporating Talon Secure Browser File Sensitivity Engine, the system ensures data protection and minimizes the risk of sensitive data leakage. The capability to enforce policy-based actions based on file sensitivity empowers organizations to maintain data integrity and secure their proprietary information and intellectual property effectively.

1. A method comprising:
identifying, by a web browser, a first resource of an enterprise comprising a sensitivity label, wherein the sensitivity label indicates sensitivity of the first resource;
validating, by the web browser, the sensitivity label of the first resource based on content of the first resource;
based on determining that the sensitivity label of the first resource does not align with the content of the first resource, enforcing a policy for the first resource by the web browser; and
labeling the first resource based on sensitivity of the first resource, wherein labeling the first resource comprises, by the web browser,
scanning the first resource for sensitive features,
generating a signature of the first resource based on metadata of the first resource, wherein the metadata of the first resource comprises one or more of a timestamp, a location of each of one or more sensitive features in the first resource identified from scanning, and a class of data with which the first resource is associated; and
labelling the first resource with the signature.

2. The method of claim 1, wherein labelling the first resource with the signature comprises attaching the signature to the first resource or embedding the signature in the first resource.

3. The method of claim 1, wherein scanning the first resource for sensitive features comprises scanning one or more other resources accessible via hyperlinks within the first resource for sensitive features.

4. (canceled)

5. The method of claim 1, wherein the signature is encrypted.

6. (canceled)

7. (canceled)

8. (canceled)

9. (canceled)

10. The method of claim 1, further comprising scanning the first resource for risky material, wherein labeling the first resource is based on determining that the first resource does not include risky material.

11. The method of claim 10, further comprising:
based on determining that the first resource includes risky material, attempting to remove the risky material from the first resource;
based on successfully removing the risky material from the first resource, proceeding with labeling the first resource; and
based on unsuccessful removal of the risky material from the first resource, disallowing use of the first resource.

12. The method of claim 5, further comprising decrypting the signature based on detecting interaction by a user with the first resource.

13. The method of claim 1, wherein enforcing the policy for the first resource is based on detecting interaction by a user with the first resource.

14. The method of claim 1, wherein enforcing the policy for the first resource comprises the web browser blocking at least one of upload, download, and opening of the first resource.

15. One or more non-transitory computer-readable media having program code stored thereon, the program code comprising instructions to:
identify, by a web browser, a first resource of an enterprise comprising a sensitivity label, wherein the sensitivity label indicates sensitivity of the first resource;
validate, by the web browser, the sensitivity label of the first resource based on content of the first resource;
based on a determination that the sensitivity label of the first resource does not align with the content of the first resource, enforce a policy for the first resource by the web browser; and
label the first resource based on sensitivity of the first resource, wherein the instructions to label the first resource comprise instructions to, by the web browser, scan the first resource for sensitive features,
generate a signature of the first resource based on metadata of the first resource, wherein the metadata of the first resource comprises one or more of a timestamp, a location of each of one or more sensitive features in the first resource identified from scanning, and a class of data with which the first resource is associated; and
label the first resource with the signature.

16. The non-transitory computer-readable media of claim 15, wherein the instructions to label the first resource with the signature comprise instructions to attach the signature to the first resource or embed the signature in the first resource.

17. The non-transitory computer-readable media of claim 15, wherein the instructions to scan the first resource for sensitive features comprise instructions to scan one or more other resources accessible via hyperlinks within the first resource for sensitive features.

18. The non-transitory computer-readable media of claim 15, wherein the signature is encrypted, wherein the program code further comprises instructions to decrypt the signature based on detecting interaction by a user with the first resource.

19. The non-transitory computer-readable media of claim 15, wherein the program code further comprises instructions to scan the first resource for risky material, wherein the instructions to label the first resource comprise instructions to label the first resource based on a determination that the first resource does not include risky material.

20. The non-transitory computer-readable media of claim 15, wherein the instructions to enforce the policy for the first resource comprise instructions to enforce the policy for the first resource based on detection of interaction by a user with the first resource.

21. The non-transitory computer-readable media of claim 15, wherein the instructions to enforce the policy for the first resource comprise instructions to, by the web browser, block at least one of upload, download, and opening of the first resource.

22. A user equipment comprising:
a processor; and
a machine-readable medium having instructions stored thereon that are executable by the processor to cause the user equipment to,
identify, by a web browser installed on the user equipment, a first resource of an enterprise comprising a sensitivity label, wherein the sensitivity label indicates sensitivity of the first resource;
validate, by the web browser, the sensitivity label of the first resource based on content of the first resource;
based on a determination that the sensitivity label of the first resource does not align with the content of the first resource, enforce a policy for the first resource by the web browser; and
label the first resource based on sensitivity of the first resource, wherein the instructions executable by the processor to cause the user equipment to label the first resource comprise instructions executable by the processor to cause the user equipment to, by the web browser,
scan the first resource for sensitive features,
generate a signature of the first resource based on metadata of the first resource, wherein the metadata of the first resource comprises one or more of a timestamp, a location of each of one or more sensitive features in the first resource identified from scanning, and a class of data with which the first resource is associated; and
label the first resource with the signature.

23. The user equipment of claim 22, wherein the instructions executable by the processor to cause the user equipment to enforce the policy for the first resource comprise instructions executable by the processor to cause the user equipment to enforce the policy for the first resource based on detection of interaction by a user with the first resource.

24. The user equipment of claim 22, wherein the instructions executable by the processor to cause the user equipment to enforce the policy for the first resource comprise instructions executable by the processor to cause the user equipment to, by the web browser, block at least one of upload, download, and opening of the first resource.

25. The user equipment of claim 22, wherein the instructions executable by the processor to cause the user equipment to scan the first resource for sensitive features comprise instructions executable by the processor to cause the user equipment to scan one or more other resources accessible via hyperlinks within the first resource for sensitive features.
